(19) United States
(12) Patent Application Publication
(10) Pub. No.: US 2024/0326592 A1
(43) Pub. Date: Oct. 3, 2024

(54) VEHICLE INFORMATION DISPLAY WITH SELECTIVE LOCAL DIMMING

(71) Applicant: Continental Automotive Systems, Inc., Auburn Hills, MI (US)

(72) Inventors: Daniel Cashen, Troy, MI (US); Piyush Anam, Troy, MI (US); Bill Breault, White Lake, MI (US)

(73) Assignee: Continental Automotive Systems, Inc., Auburn Hills, MI (US)

(21) Appl. No.: 18/579,792

(22) PCT Filed: Jul. 12, 2022
(86) PCT No.: PCT/US2022/036771

§ 371 Date: Jan. 16, 2024

Related U.S. Application Data
(60) Provisional application No. 63/221,787, filed on Jul. 14, 2021.

(51) Int. Cl. B60K 35/22

(52) U.S. Cl. CPC B60K 35/22; B60K 2360/332; B60K 2360/336; B60K 2360/34

(57) ABSTRACT

A vehicle information display assembly comprises a digital display including a plurality of tell-tales, a first illumination source to provide light to the display, a light guide to transmit the light from the first illumination source to the digital display in an even manner, wherein the light guide defines a plurality of apertures each in a region of one of the plurality of tell-tales, and a plurality of second illumination sources, each proximate to one of the plurality of apertures in the light guide such that one of the plurality of second illumination sources may be activated when a corresponding one of the plurality of tell-tales is activated. A method of communicating information relating to a vehicle operating parameter, and a vehicle information display assembly are also disclosed.

### CROSS REFERENCE TO RELATED APPLICATIONS

This U.S. patent application claims the benefit of PCT patent application No. PCT/US2022/036771, filed Jul. 12, 2022, which claims the benefit of U.S. patent application No. 63/221,787, filed Jul. 14, 2021, both of which are hereby incorporated by reference.

### TECHNICAL FIELD

The present disclosure relates to vehicle information communication display, and more specifically to tell-tales for communicating information to a vehicle operator.

### BACKGROUND

Vehicles include instrument panels to communicate information indicative of operation to an operator. Motor vehicles include instrument panels with several gauges and dials that communicate vehicle conditions such as speed, engine rpm, temperature, oil pressure along with many other operational parameters. The instrument panels also include images that illuminate to alert an operator to specific conditions of the vehicle. These images are known as tell-tales and are activated to alert a driver of a condition that requires attention such as a check engine light, or a light that indicates that the tires require attention.

The tell-tales typically are intended to alert the driver that something requires additional attention. For example, in the case of a check engine light, the operator is simply prompted to have a vehicle service department check the vehicle. Most of the time, the information is only required when a vehicle operating parameter is outside of desired operating ranges. Therefore, it is desirable to quickly draw the operator's attention to the tell-tale that is illuminated.

When a digital tell-tale is illuminated the backlight for an instrument panel is increased, sometimes to full luminance, to support the required illumination of the appropriate tell-tale. However, this additional unwanted luminance compromises the perceived contrast ratio for the entirety of the display.

The background description provided herein is for the purpose of generally presenting a context of this disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

In one aspect of the disclosure, a vehicle information display assembly comprises a digital display including a plurality of tell-tales, a first illumination source to provide light to the display, a light guide to transmit the light from the first illumination source to the digital display in an even manner, wherein the light guide defines a plurality of apertures each in a region of one of the plurality of tell-tales, and a plurality of second illumination sources, each proximate to one of the plurality of apertures in the light guide such that one of the plurality of second illumination sources may be activated when a corresponding one of the plurality of tell-tales is activated.

In another aspect of the disclosure, a method of communicating information relating to a vehicle operating parameter comprises lighting a digital display with a first illumination source through light directed by a light guide, and illuminating one of a plurality of tell-tales by actuating one of a plurality of second illumination sources associated with the one of the plurality of tell-tales.

In another aspect of the disclosure, a vehicle information display assembly comprises a display including a plurality of tell-tales, a first illumination source to provide light to the display, a light guide to transmit the light from the first illumination source to the display in an even manner, wherein the light guide defines a plurality of apertures each in a region of one of the plurality of tell-tales, and a plurality of second illumination sources, each proximate to one of the plurality of apertures in the light guide such that one of the plurality of second illumination sources may be activated when a corresponding one of the plurality of tell-tales is activated.

Other aspects and advantages will become more apparent upon consideration of the following detailed description and the attached drawings wherein like numerals designate like structures throughout the specification.

### BRIEF DESCRIPTION OF THE DRAWINGS

FIG. 1 is a schematic view of an example backlight illumination for a instrument panel of the prior art;

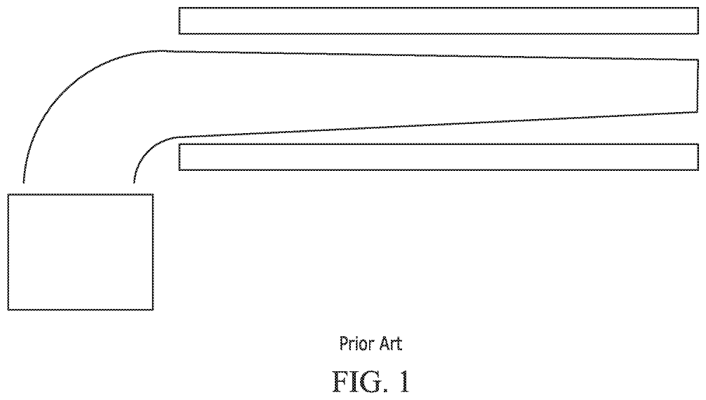

FIG. 2 is a schematic view of an example of a dashboard and instrument panel having at least one tell-tale;

FIG. 3 is a schematic view of an example backlight illumination for the instrument panel of FIG. 2, having at least one tell-tale illuminated according to a first embodiment of the invention; and

FIG. 4 illustrates one embodiment for a method of illuminating a tell-tale for the display of FIGS. 2-3.

### DETAILED DESCRIPTION

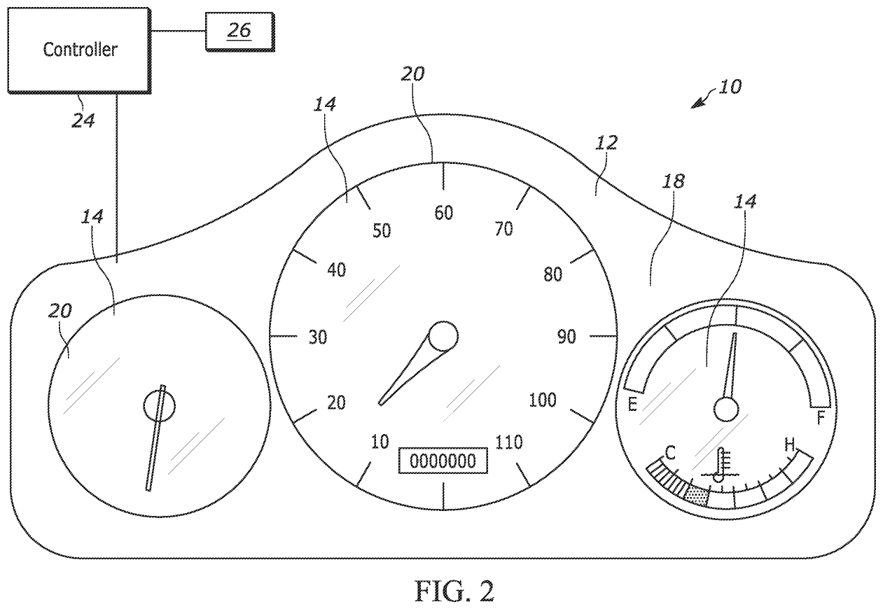

Referring to FIG. 2, a vehicle dashboard 10 is shown and includes an instrument panel 12 that includes gauges 14. The gauges 14 may be analog, electronic, or full digital gauges. A display 18 is supported within the dashboard separate from the steering wheel 16 (not shown). Similarly, the display may be a conventional display cluster or may be an electronic, or full digital display. A controller 24 is provided that is operable to control operation of the display 18. The controller 24 is configured with various vehicle systems to provide information to at least one of the display 18 that is indicative of current vehicle operating conditions. The tell-tales 20 shown on the display 18 include icons and symbols that are recognized and intuitively communicate the particular system or vehicle operating parameter.

Actuation of one of the tell-tales 20 to alert the vehicle operator may include changing of tell-tale's color or increasing the illumination brightness. The image of the tell-tale 20 may be otherwise changed in a manner to alert a vehicle operator in other ways, such as blinking. Typical tell-tales operate simply to alert a vehicle operator that a problem or condition exists.

The example controller 24 is in communication with various systems 26, such as the tire pressure monitoring system, engine, entertainment system and communication system. The controller 24 uses the information from the various systems 26 to generate an alert with the corresponding one of the plurality of tell-tales 20 in response to a predefined condition. The predefined condition can include out of range conditions such as low tire pressure, or engine oil levels.

The display 18 includes the plurality of the tell-tales 20 that provide information on different vehicle operating systems. In operation, an out of range condition communicated to the controller 24, for example from the engine will cause the controller 24 to actuate a tell-tale 30 which directs attention to that particular tell-tale.

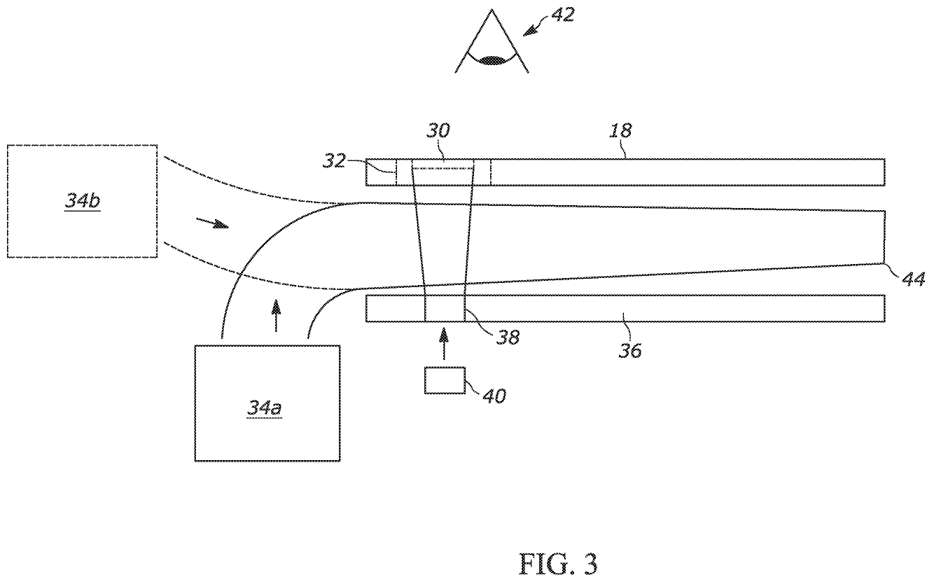

Referring to FIG. 3, with continued reference to FIG. 2 the tell-tale 30 is shown, illustrated in phantom. The display 18 has the tell-tale 30, which is configured to be illuminated in the region 32, illustrated in phantom. Although only the tell-tale 30 is shown and described herein, other tell-tales of the plurality of tell-tales 20 may have similar predefined regions of illumination and arrangements and methods for providing illumination as illustrated in FIG. 3.

An illumination source 34a is illustrated for providing backlight illumination to the display 18. In an embodiment, an illumination source 34b, illustrated in phantom, may provide edge backlight illumination to the display 18. In an embodiment, a combination of backlight illumination and edge backlight illumination provide the illumination to the display 18. The light guide 36 directs the light from the illumination source 34, 34a-34b through the light guide 36 to the display 18 and helps to ensure even back-lighting of the display 18 to an average observer 42, located on the other side of the display, illustrated at 36. As shown a light tube 44 may be used to funnel light from a first illumination source 34, 34a-34b. In an embodiment, no light tube is necessary.

An aperture 38 is defined by the guide at a location which corresponds to the region 32 for displaying the tell-tale 30. A second illumination source 40, is located on an opposing side of the guide 36 from the tell-tale 30 proximate to the second illumination source. The second illumination source is activated by the controller 24 to provide additional illumination at the tell-tale 30. The second illumination source 40 is only activated when the controller 24 determines that the tell-tale 30 should be illuminated, such that the second illumination source 40 provides select local backlight behind only the tell-tale 30. Light is added through the aperture 38 to drive up the tell-tale 30 luminance with out driving additional, unwanted luminance to the rest of the display 18. In this manner, the scaling required across the display 18 for the black state is reduced, or even eliminated.

The aperture 38 is defined by the guide such that it is sufficiently a small enough size to not be detected by the average observer 42.

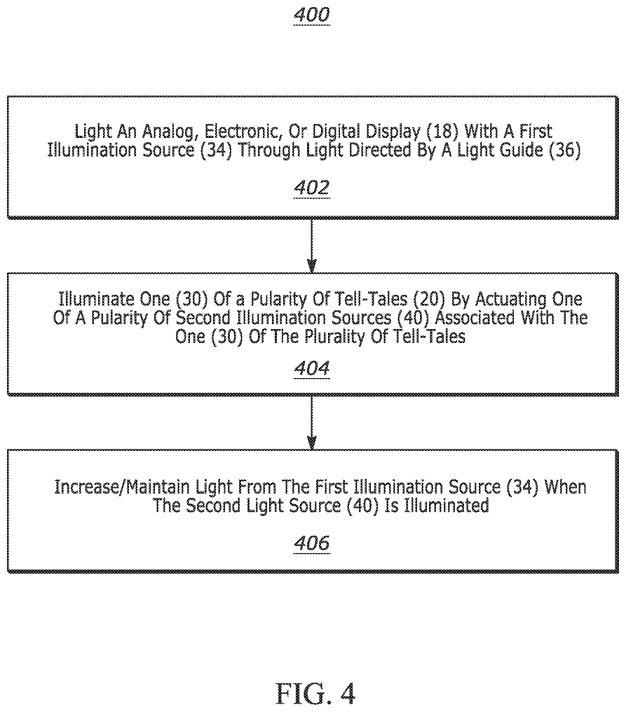

Referring to FIG. 4, one embodiment of a method of communicating information relating to a vehicle operating parameter is described. The method of communicating information includes lighting an analog, electronic, or digital display with a first illumination source through light directed by a light guide, step 402. The information also includes illuminating one of a plurality of tell-tales 20 by actuating one of a plurality of second illumination sources associated with the one of the plurality of tell-tales 20, step 404. The method as recited may include locating each of the plurality of tell-tales proximate to each of a plurality of apertures defined in the light guide, where each of the plurality of apertures are located proximate to each of the plurality of tell-tales. The plurality of apertures are smaller than can be detected by an observer 42 from an opposing side of the display.

The method as recited may include increasing the amount of black light provided by the first illumination source when one of the plurality of tell-tales is actuated, step 406. The method as recited may include increasing in light by the first illumination source when the second light source is illuminated less than increasing the light by the first illumination source when the second light source is not illuminated. The method as recited may include maintaining the amount of black light provided by the first illumination source at a constant amount when one of the plurality of tell-tales is actuated, step 406.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

What is claimed is:

1. A vehicle information display assembly comprising:
a digital display including a plurality of tell-tales;
a first illumination source to provide light to the display;
a light guide to transmit the light from the first illumination source to the digital display in an even manner, wherein the light guide defines a plurality of apertures each in a region of one of the plurality of tell-tales; and
a plurality of second illumination sources, each proximate to one of the plurality of apertures in the light guide such that one of the plurality of second illumination sources may be activated when a corresponding one of the plurality of tell-tales is activated.

2. The vehicle information display as recited in claim 1, wherein the second plurality of illumination sources are each an LED.

3. The vehicle information display as recited in claim 1, wherein the plurality of apertures are smaller than can be detected by an observer from an opposing side of the digital display.

4. The vehicle information display as recited in claim 1, wherein the amount of black light provided by the first illumination source is increased when one of the plurality of tell-tales is actuated.

5. The vehicle information display as recited in claim 4, wherein the increase in light by the first illumination source when the second light source is illuminated is less than when the second light source is not illuminated.

6. The vehicle information display as recited in claim 1, wherein the amount of black light provided by the first illumination source is not increased when one of the plurality of tell-tales is actuated.

7. A method of communicating information relating to a vehicle operating parameter comprising:
lighting a digital display with a first illumination source through light directed by a light guide; and
illuminating one of a plurality of tell-tales by actuating one of a plurality of second illumination sources associated with the one of the plurality of tell-tales.

8. The method as recited in claim 7, further comprising locating each of the plurality of tell-tales proximate to each of a plurality of apertures defined in the light guide, wherein each of the plurality of apertures are located proximate to each of the plurality of tell-tales.

9. The method as recited in claim 7, wherein the plurality of apertures are smaller than can be detected by an observer from an opposing side of the digital display.

10. The method as recited in claim 9, further comprising increasing the amount of black light provided by the first illumination source when one of the plurality of tell-tales is actuated.

11. The method as recited in claim 10, further comprising increasing light from the first illumination source when the second light source is illuminated less than increasing the light by the first illumination source when the second light source is not illuminated.

12. The method as recited in claim 7, further comprising maintaining the amount of black light provided by the first illumination source at a constant amount when one of the plurality of tell-tales is actuated.

13. A vehicle information display assembly comprising:
a display including a plurality of tell-tales;
a first illumination source to provide light to the display;
a light guide to transmit the light from the first illumination source to the display in an even manner, wherein the light guide defines a plurality of apertures each in a region of one of the plurality of tell-tales; and
a plurality of second illumination sources, each proximate to one of the plurality of apertures in the light guide such that one of the plurality of second illumination sources may be activated when a corresponding one of the plurality of tell-tales is activated.

14. The vehicle information display as recited in claim 13, wherein the display is a digital display.

15. The vehicle information display as recited in claim 13, wherein the first illumination source is an edge backlight illumination source.
